(19) United States
(12) Patent Application Publication
(10) Pub. No.: US 2025/0146723 A1
(43) Pub. Date: May 8, 2025

(54) TEMPERATURE ADJUSTMENT APPARATUS AND SENSING SYSTEM

(71) Applicant: FUJI ELECTRIC CO., LTD., Kanagawa (JP)

(72) Inventors: Hiroto KIKUCHI, Matsumoto-city (JP); Katsuyuki UEMATSU, Matsumoto-city (JP)

(21) Appl. No.: 18/893,969

(22) Filed: Sep. 24, 2024

(30) Foreign Application Priority Data
Nov. 8, 2023 (JP) 2023-190601

(51) Int. Cl. F25B 41/42; F25B 49/00

(52) U.S. Cl. CPC F25B 41/42; F25B 49/00; F25B 2700/19

(57) ABSTRACT

Provided is a temperature adjustment apparatus that performs thermal exchange with one or more objects by means of cooling water, the temperature adjustment apparatus comprising a distribution portion including a distribution channel through which the cooling water is distributed and a sensing system that senses a state of the distribution channel, wherein the sensing system includes a pressure sensor provided at at least one position in the distribution channel, that senses pressure of the cooling water and a sensing unit that senses a state of the distribution channel based on the pressure sensed by the pressure sensor.

The contents of the following patent application(s) are incorporated herein by reference: NO. 2023-190601 filed in JP on Nov. 8, 2023

### BACKGROUND

### 1. Technical Field

The present invention relates to a temperature adjustment apparatus and a sensing system.

### 2. Related Art

Conventionally, a thermal management system that uses a liquid coolant is known (for example, see patent documents 1 and 2).
Patent Document 1: Japanese Patent Application Publication No. 2014-80123
Patent Document 2: Japanese Patent Application Publication No. 2011-255879

### BRIEF DESCRIPTION OF THE DRAWINGS

FIG. 1 illustrates a configuration example of a temperature adjustment apparatus 300 according to an embodiment of the present invention.

FIG. 2 illustrates an attachment example of a pressure sensor 110 to a distribution channel.

FIG. 3 is a top view of the pressure sensor 110 illustrated in FIG. 2.

FIG. 4 is a cross-sectional view illustrating an exemplary structure of the pressure sensor 110 illustrated in FIG. 2.

FIG. 5 is a cross-sectional view illustrating another exemplary structure of the pressure sensor 110 illustrated in FIG. 2.

FIG. 6 is an example of a top view of a sensor cell 140.

FIG. 7 illustrates another attachment example of the pressure sensor 110 to the distribution channel.

FIG. 8 illustrates an example of a top view of the sensor cell 140.

FIG. 9 is a schematic view describing an example of a connection control unit 202.

FIG. 10 is a schematic view describing an example of the connection control unit 202.

FIG. 11 is a top view describing an example of a sensor module 160.

FIG. 12 is an example of a cross-sectional view of the sensor module 160 illustrated in FIG. 11.

FIG. 13 illustrates another configuration example of a distribution portion 200.

FIG. 14 illustrates another configuration example of the distribution portion 200.

### DESCRIPTION OF EXEMPLARY EMBODIMENTS

Hereinafter, the present invention will be described through embodiments of the invention, but the following embodiments do not limit the invention according to the claims. In addition, not all of the combinations of features described in the embodiments are essential to the solution of the invention. Note that in the present specification and the diagrams, elements having substantially the same function and architecture are denoted with a same reference sign to omit duplicated descriptions, and illustrations of elements that are not directly related to the present invention will be omitted. Further, in one diagram, elements having the same functions and architecture are denoted by a representative reference sign, and other reference signs for the elements may be omitted.

In the present specification, a case where a term such as “same” or “equal” is mentioned may include a case where an error due to a variation in manufacturing or the like is included. The error is, for example, within 10%.

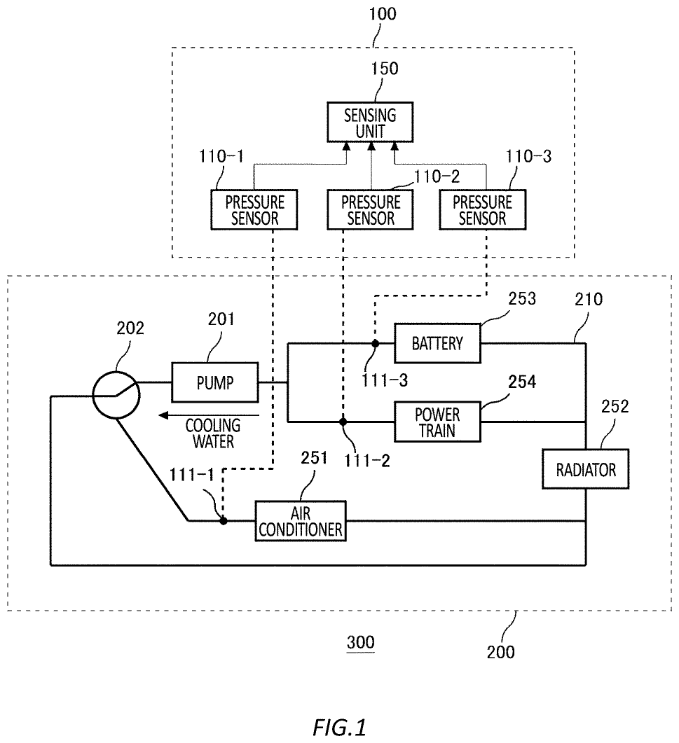

FIG. 1 illustrates a configuration example of a temperature adjustment apparatus 300 according to an embodiment of the present invention. The temperature adjustment apparatus 300 performs thermal exchange with one or more objects by means of a cooling water (also referred to as a liquid coolant). In this manner, the temperature of each object is adjusted. The cooling water may include, as its principal component, a liquid with higher freeze resistance than water. Herein, a principal component may refer to a component with a weight ratio that is greater than 50% relative to the entire cooling water. The principal component of the cooling water may be ethylene glycol or propylene glycol. The principal component of the cooling water may be water. An anti-rust agent may be added to the cooling water.

Although the temperature adjustment apparatus 300 of the present example is used in a vehicle, the temperature adjustment apparatus 300 may be used for other applications. The vehicle of the present example generates at least a part of the power by electrical power. The object to be cooled in the present example is an air conditioner 251, a radiator 252, a battery 253, a power train 254 and the like used in the vehicle. The object to be cooled is not limited thereto. The air conditioner 251 adjusts the temperature inside the vehicle.

The temperature adjustment apparatus 300 includes a distribution portion 200 including a distribution channel through which the cooling water is distributed and a sensing system 100 that senses a state of the distribution channel. The distribution channel includes a plurality of tubing 210 through which the cooling water flows. The tubing 210 may be formed of metal, resin, or the like. The distribution channel may include, in addition to the tubing 210, an apparatus that controls the flow speed, the flow rate, the circulation channel or the like of the cooling water, such as a pump 201 and a connection control unit 202. The distribution channel may include a heat exchanger that exchanges heat between the cooling water and another medium or the like.

The tubing 210 may provide connection among each apparatus. The distribution channel of the present example includes an annular portion through which the cooling water is circulated. In FIG. 1, the tubing 210 between each apparatus is illustrated with solid lines. The tubing 210 passes near an object such as the battery 253. In this manner, thermal exchange is caused between the object such as the battery 253 and cooling water, to cool the object. The tubing 210 may be provided to be in contact with the object.

The pump 201 takes in the cooling water from the tubing 210, and sends the cooling water to the tubing 210. In this manner, the cooling water is circulated through the distribution channel. A plurality of the pumps 201 may be provided in the distribution channel.

The connection control unit 202 controls which of the tubing 210, of the plurality of tubing 210, are to be connected together. The connection control unit 202 is connected to three or more tubing 210, and may connect any two tubing 210 together. In this manner, which of the tubing 210 the cooling water is to be circulated through can be controlled. The connection control unit 202 in the example of FIG. 1 can switch whether to circulate the cooling water from the pump 201 through the tubing 210 that cools the air conditioner 251 or through another tubing 210. The connection control unit 202 may be a solenoid valve that switches a connection of the internal channel by means of an electromagnet, may be an electronic valve that switches the connection of the internal channel by means of an electrical signal, or may be another type of valve.

The sensing system 100 includes at least one pressure sensor 110 and a sensing unit 150. The pressure sensor 110 is provided at at least one placement position 111 in the distribution channel, and senses the pressure of the cooling water at said placement position 111. The pressure sensor 110 of the present example is provided at a position in contact with the cooling water.

The pressure sensor 110 may be provided in the tubing 210, or may be provided in an apparatus on the distribution channel, such as the pump 201, the connection control unit 202, and the like. In the example of FIG. 1, pressure sensors 110-1, 110-2, and 110-3 are provided at placement positions 111-1, 111-2, and 111-3 of the tubing 210. The pressure sensor 110 may be a semiconductor pressure sensor constituted by forming a diaphragm on a semiconductor substrate, or may be a pressure sensor of another structure.

The sensing unit 150 senses a state of the distribution channel based on the pressure sensed by the pressure sensor 110. For example, the sensing unit 150 compares the pressure sensed by each pressure sensor 110 with a reference value that is set. The reference value may be a value that is 80 kPa or more and 300 kPa or less. The sensing unit 150 may provide a warning to a user such as a driver of the vehicle when the difference between the sensed pressure and the reference value falls out of a permissible range.

For example, in the distribution channel such as the tubing 210, a component included in the cooling water may be deposited, or a foreign substance mixed in the cooling water may be attached. When these substances are accumulated, the inner diameter of the distribution channel becomes small, which causes difficulty in distribution of the cooling water. When the inner diameter of the distribution channel becomes too small, the object cannot be cooled. When the inner diameter of the distribution channel becomes small, the pressure of the cooling water upstream of said location is increased. Thus, by monitoring the pressure sensed by the pressure sensor 110, reduction of the inner diameter of the distribution channel can be sensed. In addition, failure of the distribution channel can be sensed before the distribution channel is completely clogged. In addition, when the cooling water leaks from the distribution channel, the pressure of the cooling water is reduced. Thus, by monitoring the pressure sensed by the pressure sensor 110, leakage of the cooling water can be sensed.

The sensing unit 150 may identify where the inner diameter is reduced based on the detection result by the plurality of pressure sensors 110. For example, when a pressure increase is not sensed by a downstream pressure sensor 110, while a pressure increase is sensed by an upstream pressure sensor 110, it may be determined that a reduction in the inner diameter has occurred in the distribution channel between said two pressure sensors 110. Similarly, the sensing unit 150 may identify where leakage of the cooling water has occurred based on the detection result by the plurality of pressure sensors 110. The sensing unit 150 may inform the user of the location where the failure is sensed.

The sensing unit 150 may have a common reference value set for each pressure sensor 110. On the other hand, there may be cases where the pressure of the cooling water in a normal state is different depending on the position of the distribution channel. For example, a normal pressure value may be different depending on the distance from the pump 201, the distance from a curved part of the distribution channel, the inner diameter of the distribution channel or the like. The sensing unit 150 may have a reference value set individually for each pressure sensor 110.

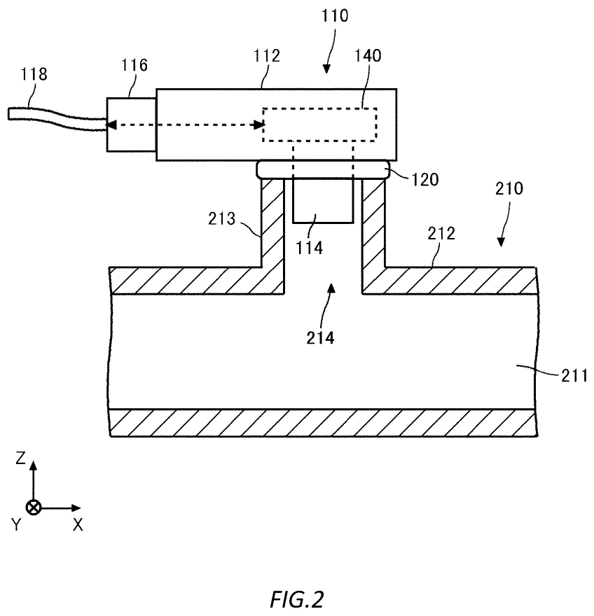

FIG. 2 illustrates an attachment example of the pressure sensor 110 to the distribution channel. Although the distribution channel of the present example is the tubing 210, the pressure sensor 110 can be attached similarly to an apparatus other than the tubing 210.

The pressure sensor 110 of the present example includes an intake unit 114, a sensor cell 140, a housing 112, a connector 116, and a wiring 118. In addition, the tubing 210 includes a wall 212 that surrounds a space 211 through which the cooling water passes. In FIG. 2, a cross section of the wall 212 is illustrated. The wall 212 may be formed of metal, resin, or the like. An opening 214 is provided on the wall 212. The position of the opening 214 corresponds to the placement position 111 in FIG. 1.

The intake unit 114 is connected to the opening 214. The wall 212 of the present example includes a protruding portion 213 that protrudes from the opening 214. The protruding portion 213 has a cylindrical shape. The internal space surrounded by the protruding portion 213 is connected to the space 211 via the opening 214. The intake unit 114 is inserted into the internal space of the protruding portion 213 to take in the cooling water into the housing 112. An encapsulating member 120 such as a O-ring may be provided between the housing 112 and the protruding portion 213.

The sensor cell 140 is accommodated inside the housing 112. The housing 112 is formed of an insulating material such as resin, for example. The sensor cell 140 senses the pressure of the cooling water taken in by the intake unit 114. The sensor cell 140 is in contact with the cooling water inside the housing 112.

The sensor cell 140 is electrically connected to the wiring 118 via the connector 116. The sensor cell 140 outputs an electrical signal indicating the magnitude of the pressure of the cooling water to the sensing unit 150 via the wiring 118. With such a configuration, the pressure of the cooling water flowing through the distribution channel can be sensed.

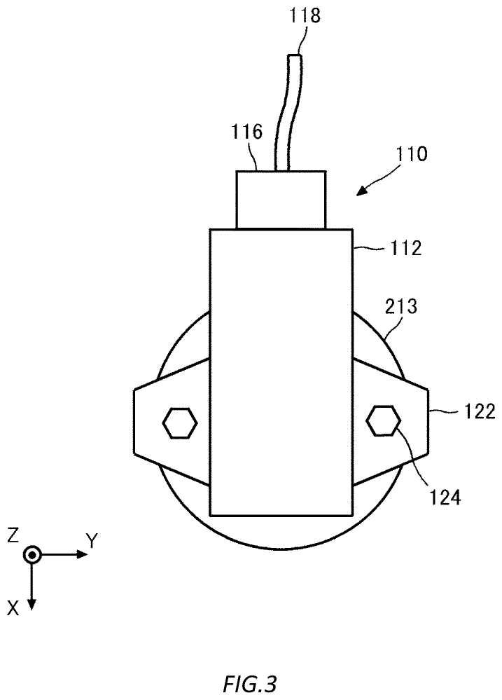

FIG. 3 is a top view of the pressure sensor 110 illustrated in FIG. 2. Although illustration thereof is omitted in FIG. 2, the protruding portion 213 of the present example includes a flange at a portion where it is connected to the pressure sensor 110. The pressure sensor 110 may be fixed to the flange of the protruding portion 213 by means of a screw 124 or the like. The housing 112 may include a protruding portion 122 in which the screw 124 is arranged.

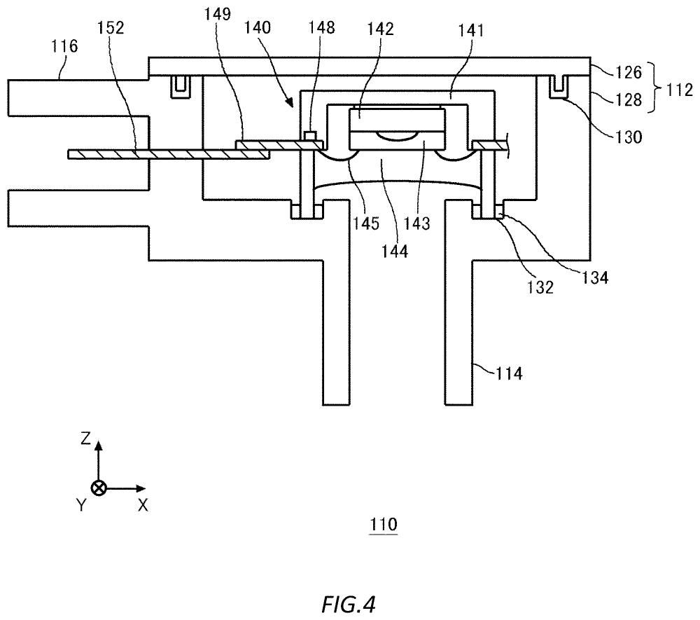

FIG. 4 is a cross-sectional view illustrating an exemplary structure of the pressure sensor 110 illustrated in FIG. 2. The pressure sensor 110 of the present example includes a housing 112, an intake unit 114, a sensor cell 140, and a connector 116.

The sensor cell 140 is accommodated in an internal space of the housing 112. The housing 112 may include a major portion 128 having provided therein a concave portion in which the sensor cell 140 is accommodated, and a lid portion 126 that covers said concave portion. The lid portion 126 and the major portion 128 may be tightly closed by an adhesive material 130.

Although the sensor cell 140 of the present example is an absolute pressure sensor that measures an absolute pressure of the cooling water, it may be a relative pressure sensor that measures a relative pressure of the cooling water. The absolute pressure is a pressure when assuming that the magnitude of vacuum pressure is zero. The relative pressure is a difference in the pressure between the pressure to be measured and a predetermined reference pressure. The sensor cell 140 of the present example includes an accommodating portion 141, a base material 142, a semiconductor substrate 143, a wiring 145, a terminal 149, and an encapsulating portion 144. The accommodating portion 141 accommodates the base material 142, the semiconductor substrate 143, and the encapsulating portion 144. The accommodating portion 141 may be formed of an insulating material such as resin. The accommodating portion 141 may include polyphenylene sulfide (PPS). By the accommodating portion 141 including PPS, swelling or degradation of the accommodating portion 141 caused by the cooling water can be suppressed. The accommodating portion 141 is fixed to the housing 112. The accommodating portion 141 of the present example includes a protrusion to be inserted into the concave portion 132 provided on the housing 112. The concave portion 132 is filled with the adhesive material 134 to fix the protrusion therein.

The base material 142 is fixed to the accommodating portion 141 by means of an adhesive material or the like. The semiconductor substrate 143 is provided on a front surface of the base material 142. The base material 142 may be a glass substrate, or may be a substrate of another material.

The semiconductor substrate 143 of the present example as at least a part of its region thinned. The thinned region functions as a diaphragm. The diaphragm is pressed by the cooling water taken in by the intake unit 114, which causes distortion. The diaphragm of the present example is arranged to face the intake unit 114. The resistance value of the diaphragm changes according to the magnitude of the distortion. The semiconductor substrate 143 may be provided with a circuit that generates a sensing signal with a signal level according to said resistance value. The sensing signal is transmitted to the terminal 149 through the wiring 145 such as a wire.

The encapsulating portion 144 encapsulates the semiconductor substrate 143, the base material 142, and the wiring 145. The encapsulating portion 144 is formed of an insulating material. The encapsulating portion 144 is a silicone gel, for example, but is not limited thereto. The encapsulating portion 144 is brought into contact with the cooling water that is taken in by the intake unit 114.

The terminal 149 is a wiring that is exposed the outside of the encapsulating portion 144 and the accommodating portion 141. The terminal 149 may be a board-shaped lead frame. The sensor cell 140 may include a plurality of terminals 149. Any of the terminals 149 may transmit the sensing signal. Any of the terminals 149 may apply a power voltage to the circuit that generates the sensing signal. Any of the terminals 149 may apply a reference voltage such as ground voltage to the circuit that generates the sensing signal. The circuit that generates the sensing signal may be formed on another semiconductor substrate that is separate from the semiconductor substrate 143. The other semiconductor substrate may also be arranged in the sensor cell 140.

The pressure sensor 110 may include a wiring 152. The wiring 152 connects the terminal 149 and the connector 116. The wiring 152 may be connected to the wiring 118 illustrated in FIG. 2 or the like. The wiring 152 may be a board-shaped lead frame.

The sensor cell 140 may further include a chip capacitor 148. The chip capacitor 148 connects two terminals 149. In this manner, superimposition of noise on the sensing signal can be suppressed, or malfunctioning can be prevented when strong electromagnetic field noise is induced in the wiring. The chip capacitor 148 may be connected to the terminal 149 inside the accommodating portion 141, or may be connected to the terminal 149 outside the accommodating portion 141.

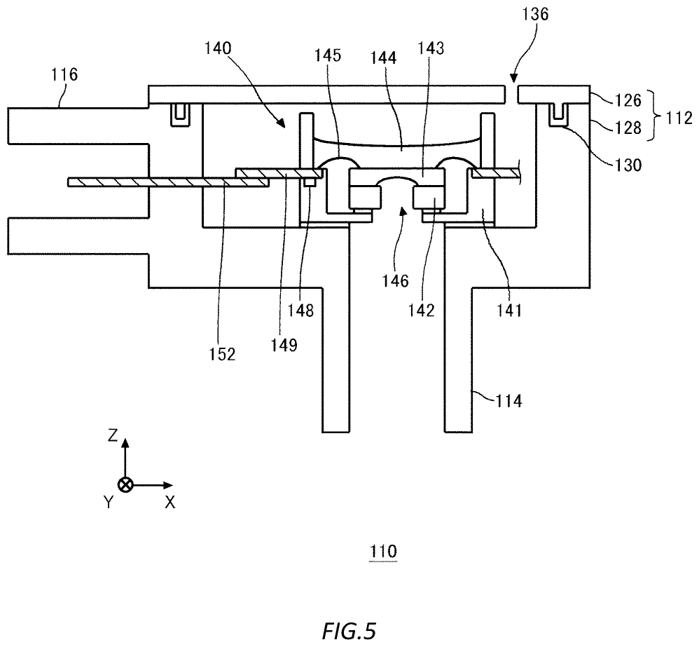

FIG. 5 is a cross-sectional view illustrating another exemplary structure of the pressure sensor 110 illustrated in FIG. 2. The sensor cell 140 of the present example is a relative pressure sensor that detects a difference between the reference pressure such as atmospheric pressure and the pressure of the cooling water. Other than the structure of the sensor cell 140, it may be similar to the example illustrated in FIG. 4. Note that, the lid portion 126 of the present example is provided with a through-hole 136 through which atmosphere is introduced to the internal space in which the sensor cell 140 is provided. The sensor cell 140 of the present example measures the relative pressure, assuming the atmospheric pressure as the reference pressure. Note that, a configuration in which the through-hole 136 is not provided and the absolute pressure is measured may be adopted.

The sensor cell 140 of the present example is provided with the through-hole 146 in its base material 142. The through-hole 146 exposes the back surface of the diaphragm. The diaphragm is distorted according to the difference between the pressure applied to the front surface covered by the encapsulating portion 144 and the pressure applied to the back surface exposed in the through-hole 146. The sensor cell 140 generates a sensing signal according to the magnitude of said distortion. In the sensor cell 140 of the present example, the pressure of the cooling water is applied on the back surface of the diaphragm and a reference pressure such as atmospheric pressure is applied on the front surface of the diaphragm. The housing 112 of the present example includes structure which a space into which atmosphere is introduced and a space into which the cooling water is introduced are separated. Other structures of the sensor cell 140 are similar to those in the example of FIG. 4.

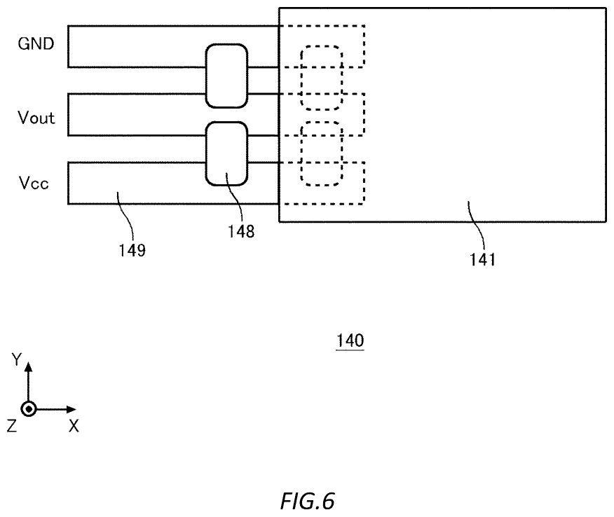

FIG. 6 is an example of a top view of the sensor cell 140. In FIG. 6, illustration of structures other than the terminal 149, the accommodating portion 141, and the chip capacitor 148 are omitted. As described above, the terminal 149 is provided to extend from the inside to the outside of the accommodating portion 141. The sensor cell 140 of the present example includes three terminals 149 arranged in line on a same side of the accommodating portion 141. The sensor cell 140 of the present example includes a terminal 149 (herein, may be referred to as a power source terminal Vcc) to which the power voltage Vcc is applied, a terminal 149 (herein, may be referred to as a power source terminal GND) to which a reference voltage GND is applied, and a terminal 149 (herein, may be referred to as a output terminal Vout) that transmits a sensing signal Vout.

The chip capacitor 148 is provided between two terminals 149. The sensor cell 140 may include a plurality of chip capacitors 148. In the example of FIG. 6, the chip capacitor 148 that connects the power source terminal GND and the output terminal Vout and the chip capacitor 148 that connects the power source terminal Vcc and the output terminal Vcc are provided. The chip capacitor 148 may be provided outside the accommodating portion 141, as illustrated with solid lines in FIG. 6, or may be provided inside the accommodating portion 141, as illustrated with broken lines in FIG. 6.

The sensor cell 140 may be provided in an apparatus such as the pump 201 or the connection control unit 202. These apparatuses may include a noise source such as a solenoid valve. In the present example, by providing the sensor cell 140 with the chip capacitor 148, superimposition of the noise on the sensing signal Vout can be suppressed, and malfunctioning thereof can be prevented. Thus, even when the sensor cell 140 is arranged near the noise source, the pressure of the cooling water can be accurately sensed.

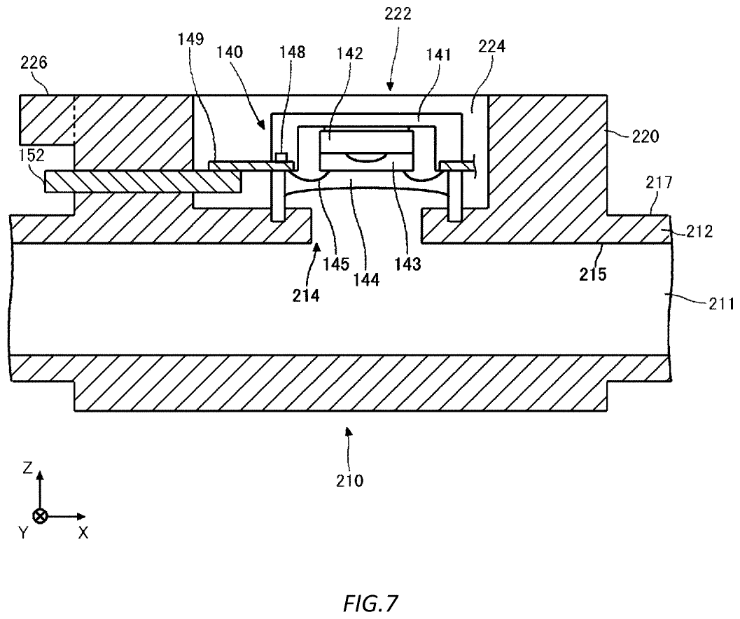

FIG. 7 illustrates another attachment example of the pressure sensor 110 to the distribution channel. The pressure sensor 110 of the present example does not include the housing 112 that accommodates the sensor cell 140. The sensor cell 140 of the present example is accommodated in the concave portion 222 provided on the wall 212 of the distribution channel such as the tubing 210. The sensor cell 140 may have structure that is similar to that in the example illustrated in FIG. 4, or may have structure that is similar to that in the example illustrated in FIG. 5. According to the present example, the pressure sensor 110 can be made compact. In addition, in an apparatus in which a plurality of tubing 210 are crowded, such as the connection control unit 202, it is easier to arrange the pressure sensor 110 in each of the tubing 210. Thus, the state of the distribution channel can be accurately sensed.

The wall 212 includes an inner surface 215 that faces the space 211 and an outer surface 217 that is a surface of the opposite side relative to the inner surface 215. The concave portion 222 is provided on the outer surface 217 of the wall 212. The concave portion 222 is connected to the space 211 through the opening 214 provided on the wall 212.

The sensor cell 140 is brought into contact with the cooling water via the opening 214. The sensor cell 140 of the present example measures the absolute pressure of the cooling water. The concave portion 222 may be filled with a encapsulating agent 224 that encapsulates the entire sensor cell 140. The encapsulating agent 224 is a silicone gel, for example. In addition, without filling the concave portion 222 with the encapsulating agent 224, a lid portion that covers the concave portion 222 may be provided similarly to FIG. 4, of a lid portion that covers the concave portion 222 and includes a through-hole may be provided similarly to FIG. 5.

The wiring 152 of the present example connects the terminal 149 and the outside of the concave portion 222. The wiring 152 may pass through the wall 212 surrounding the concave portion 222. When the wall 212 is formed of a resin material, the wiring 152 may be provided on the wall 212 by means of insert molding. In addition, a chip capacitor may be arranged in each set of adjacent wirings of the wiring 152 such that adjacent wirings are connected to each other. This chip capacitor may be provided instead of or together with the chip capacitor 148 provided in the sensor cell 140. When the wall 212 is formed of an conductive material, an insulating portion that provides insulation between the wiring 152 and the wall 212 is provided. The wiring 152 may have a distance from the wall 212.

The wall 212 may include a thick portion 220 having a larger thickness than adjacent regions. The concave portion 222 may be provided in the thick portion 220. The thick portion 220 may be part of a flange that connects the tubing 210 together

The thick portion 220 may be provided at a different location other than the flange. The thick portion 220 may be provided with a connector 226. The wall 212 may be a part of the connector 226.

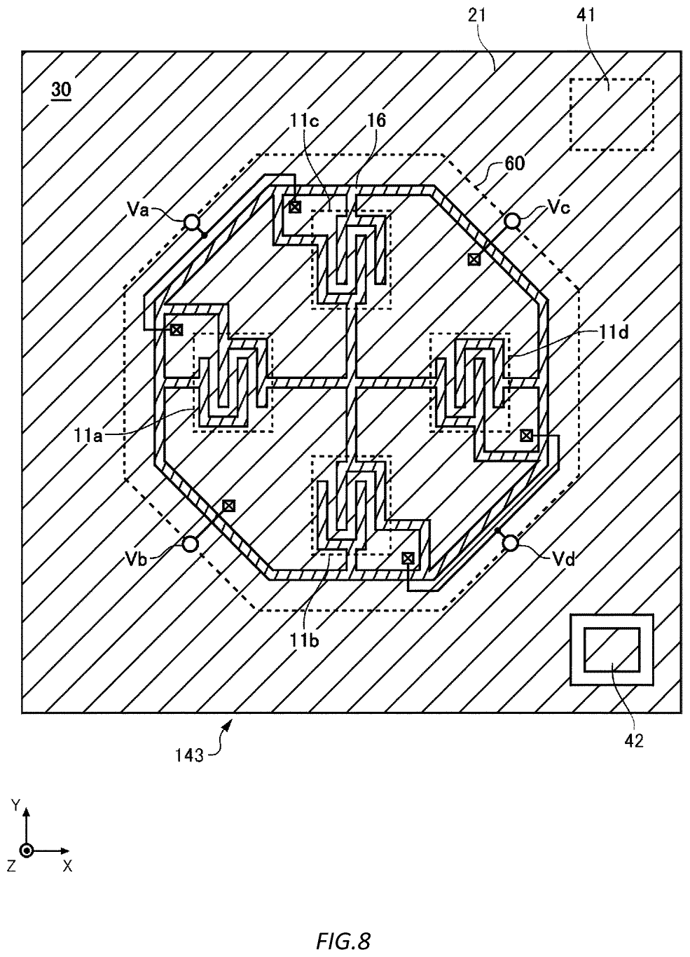

FIG. 8 illustrates an example of a top view of the semiconductor substrate 143 of the sensor cell 140. At least a part of is region of the sensor cell 140 of the present example has charging resistance, and is covered by a protective film 21 connected to the reference potential. The protective film 21 of the present example may be applied to the sensor cell 140 in any of the examples. Depending on the component of the cooling water, it becomes easier for the sensor cell 140 that is in contact with the cooling water to be charged. For example, when the viscosity of the cooling water is high, the sensor cell 140 is caused to be easily charged due to friction between the cooling water and the sensor cell 140. When the sensor cell 140 is charged, the signal level of the sensing signal is varied, which may prevent the pressure of the cooling water from being accurately sensed. The sensor cell 140 of the present example accurately senses the pressure of the cooling water by being provided with the protective film 21.

The charging resistance is resistance against electric charges that are attached on the upper surface of the sensor cell 140. The charging resistance may be a function to suppress charging of the sensor cell 140. When the electric charge that is charged on the upper surface of the sensor cell 140 is accumulated, the sensor cell 140 may malfunction. The protective film 21 functions as a shielding film that prevents malfunctioning of the sensor cell 140 caused by the charged electric charge, when the electric charge is accumulated on the upper surface of the sensor cell 140. The protective film 21 may cause the electric charge charged on the sensor cell 140 to flow to the ground potential or the like.

The protective film 21 may have corrosion resistance, in addition to the charging resistance. The corrosion resistance is resistance for corrosive substances attached to the upper surface of the sensor cell 140. In this manner, the sensor cell 140 can be protected from corrosion by the cooling water. In one example, the protective film 21 includes an acid-resistant material.

The protective film 21 of the present example includes at least one of gold or platinum. For example, the protective film 21 is a Cr/Pt/Au in which chromium (Cr), platinum (Pt), and gold (Au) are laminated in this order from the semiconductor substrate 143 side. In addition, the protective film 21 may be a Ti/Pt/Au in which titanium (Ti), platinum (Pt), and gold (Au) are laminated in this order from the semiconductor substrate 143 side.

The sensor cell 140 of the present example includes a circuit portion 30, a sensor portion 60, a first pad 41, and a second pad 42 formed on the semiconductor substrate 143. The semiconductor substrate 143 is a substrate such as Si or SiC, for example. The sensor portion 60 is a diaphragm formed on the semiconductor substrate 143. The sensor portion 60 may be a thinned region in the semiconductor substrate. The circuit portion 30 generates a sensing signal of which the signal level changes according to the change in the resistance value of the sensor portion 60.

The sensor portion 60 has a resistance portion 11 to detect change in the strain amount of the diaphragm. The sensor portion 60 in the present example is provided in the semiconductor substrate 143, which integrate the sensor portion 60 and the circuit portion 30 into one-chip.

The resistance portion 11 includes four resistance portions 11a to 11d that constitute a Wheatstone bridge. The resistance portions 11a to 11d in the present example are semiconductor strain gauges using piezoresistive elements whose resistance changes corresponding to the strain of the diaphragm. In this manner, the sensor portion 60 detects the pressure applied to the diaphragm as the resistance change.

The insulating region 16 is a region having a insulating property that is provided, in the sensor portion 60, on the upper surface of the semiconductor substrate 143.

In one example, the insulating region 16 is a region where an insulating film is provided on the upper surface of the semiconductor substrate 143. For example, the insulating region 16 has a LOCOS (Local Oxidation of Silicon) film that is formed by oxidizing the semiconductor substrate 143, or a polysilicon film. The insulating region 16 is provided in a comb shape on the upper surface of the semiconductor substrate 143. In this manner, the serpentine pattern of the resistance portion 11 is formed.

Voltages Va to Vd change according to the change in resistances in the resistance portions 11a to 11d. The voltage Va is voltage of a terminal between the resistance portion 11a and the resistance portion 11c. The voltage Vb is voltage of a terminal between the resistance portion 11a and the resistance portion 11b. The voltage Vc is voltage of a terminal between the resistance portion 11c and the resistance portion 11d. The voltage Vd is voltage of a terminal between the resistance portion 11b and the resistance portion 11d.

The circuit portion 30 is provided around the sensor portion 60. The circuit portion 30 is electrically connected to the sensor portion 60. The circuit portion 30 has a circuit such as an IC to perform processing on a signal detected by the sensor portion 60. Illustration of detailed components of the circuit portion 30 is omitted in FIG. 8. The circuit portion 30 detects the pressure applied to the diaphragm by processing the signal output by the sensor portion 60. For example, strain generated in the diaphragm by the applied pressure causes potential difference to be generated in output of the Wheatstone bridge. The circuit portion 30 converts the pressure applied to the diaphragm into an electrical signal by amplifying the potential difference of the voltages Va to Vd output by the Wheatstone bridge.

The first pad 41 and the second pad 42 are pads of conductivity that are provided above the semiconductor substrate 143. Pads such as the first pad 41 and the second pad 42 are formed of base material such as aluminum or aluminum alloy that is provided on the semiconductor substrate 143. Pads such as the first pad 41 and the second pad 42 may be formed of the same material as that of the wiring on the semiconductor substrate 143. In one example, the first pad 41 and the second pad 42 are provided at openings formed by etching the insulating film above the circuit portion 30.

The protective film 21 is provided above the semiconductor substrate 143 of the sensor cell 140. Another passivation film may be provided between the protective film 21 and the semiconductor substrate 143. The encapsulating portion 144 may be provided between the protective film 21 and the semiconductor substrate 143. In another example, the protective film 21 may be provided between the encapsulating portion 144 and the semiconductor substrate 143.

In the present example, the protective film 21 is provided above the circuit portion 30, the sensor portion 60, the first pad 41, and the second pad 42. Also, the protective film 21 preferably covers the circuit portion 30 entirely. Covering the circuit portion 30 entirely means covering above all the circuits that are provided in the circuit portion 30. Also, in the present example, the protective film 21 covers the sensor portion 60 entirely, but it may not cover a part of the sensor portion 60.

The protective film 21 on the second pad 42 and the protective film 21 on the first pad 41 are separated, and the second pad 42 is a pad that is electrically separated from the first pad 41. That is, the protective film 21 provided on the second pad 42 is electrically separated from the protective film 21 provided on the circuit portion 30 excluding on the second pad 42. The second pad 42 may be electrically connected to the outside of the sensor cell 140 via wire bonding etc., or to a circuit provided in the circuit portion 30. The first pad 41 may be a ground terminal to set the protective film 21 to the ground potential. Note that, in addition to the pads shown in the figure, pads equivalent to the first pad 41 or the second pad 42 may be provided.

The protective film 21 provided above the circuit portion 30 is set to a predetermined reference potential. The protective film 21 may be set to a potential that is same as that of the semiconductor substrate 143 of the sensor cell 140. For example, the protective film 21 is set to the ground potential. In this manner, even when the charged electric charge is attached on the upper surface of the sensor cell 140, the electric field generated by the electric charge can be shielded by the protective film 21.

The protective film 21 in the present example is provided, in addition to above the circuit portion 30, also on the first pad 41. In this manner, the protective film 21 can improve charging resistance in the circuit portion 30, while improving corrosion resistance. In this case, the sensor cell 140 does not need to provide additional film forming process, by covering the circuit portion 30 with the same material as that of the protective film covering the upper surface of the first pad 41.

The protective film 21 may be formed of different materials above the first pad 41 and the circuit portion 30, and the second pad 42. However, in case where, the protective film 21 is formed of the same material above the first pad 41 and the circuit portion 30 and the second pad 42, the film forming process is decreased in the number of steps.

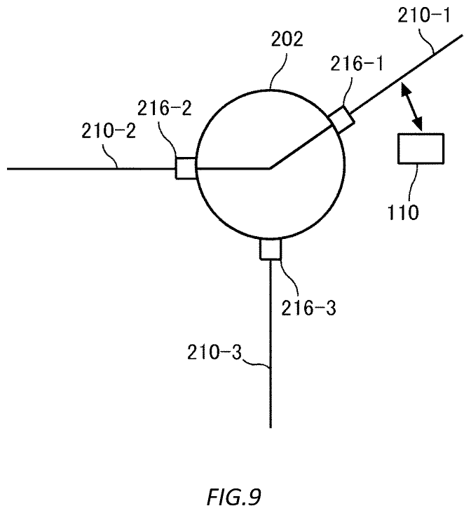

FIG. 9 is a schematic view describing an example of a connection control unit 202. The connection control unit 202 is connected to a plurality of tubing 210. The connection control unit 202 of the present example includes a plurality of connection tubes 216. Each of the connection tubes 216 is connected to a tubing 210. The connection control unit 202 switches which of the connection tubes 216 are to be connected together to switch which of the tubing 210 are to be connected together.

The connection control unit 202 of the present example switches which of the plurality of tubing 210-2, 210-3 the tubing 210-1 is to be connected to. The tubing 210-1 is an example of the major path, and the tubing 210-2, 210-3 are examples of the branch path. The connection control unit 202 of the present example switches which branch path the cooling water from the major path is to be flown through. The major path is the tubing 210 that connects the pump 201 and the connection control unit 202, for example.

In the present example, at least one pressure sensor 110 is provided in the major path. The pressure sensor 110 may be provided in the tubing 210-1, or may be provided in the connection tube 216-1 connected to the tubing 210-1.

The sensing unit 150 compares the pressure sensed by the pressure sensor 110 with a reference value that is set, and senses the state of the distribution channel based on the comparison result. The pressure to be sensed by the pressure sensor 110 is varied according to the state of the branch path connected to the major path. The sensing unit 150 of the present example senses the state of the branch path selected by the connection control unit 202, among the plurality of branch paths, based on the pressure sensed by the pressure sensor 110.

Due to the length, the structure such as the tube diameter of each branch path, the pressure to be sensed during normal operation by the pressure sensor 110 is different for each branch path. The sensing unit 150 may correct the reference value according to which branch path was selected by the connection control unit 202. Information indicating the selected state at the connection control unit 202 may be input to the sensing unit 150. When the selected state at the connection control unit 202 is controlled by an electrical signal, said electrical signal may be input to the sensing unit 150. In the sensing unit 150, a reference value to be used may be set in advance by a user or the like for each branch path. The reference value to be used may be calculated from the distribution channel structure or the like, or may be determined by measuring the pressure when the cooling water is distributed through the distribution channel in a normal state.

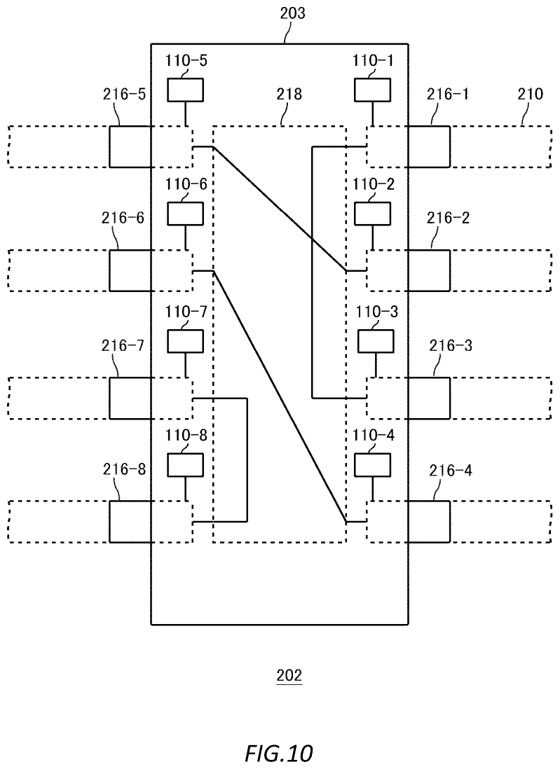

FIG. 10 is a schematic view describing an example of the connection control unit 202. The connection control unit 202 is connected to a plurality of tubing 210. The connection control unit 202 controls which of the tubing 210 among the plurality of tubing 210 are to be connected together. The connection control unit 202 may have a function of being capable of connecting any two tubing 210 among the plurality of tubing 210 with each other. The connection control unit 202 may have a function of being capable of simultaneously connecting a plurality of sets of tubing 210. For example, as illustrated in FIG. 10, when eight tubing 210 are connected to the connection control unit 202, the connection control unit 202 may simultaneously connect four sets of tubing 210, each set including two tubing 210.

The connection control unit 202 of the present example includes a main body portion 203, a plurality of connection tubes 216, and a switching unit 218. The plurality of connection tubes 216 are connected to the plurality of tubing 210 in a one-on-one manner. The switching unit 218 switches which of the connection tubes 216 are to be connected together. In this manner, which of the tubing 210 are to be connected together can be controlled. The switching unit 218 may switch which of the connection tubes 216 are to be connected together by controlling a plurality of solenoid valves.

The main body portion 203 accommodates the switching unit 218. The main body portion 203 is provided with the connection tube 216. One end of the connection tube 216 is connected to the tubing 210 outside the main body portion 203. The other end of the connection tube 216 is connected to the switching unit 218 inside the main body portion 203.

At least one pressure sensor 110 may be provided in at least one connection tube 216. The pressure sensor 110 may be provided in the connection tube 216 outside the main body portion 203, or may be provided in the connection tube 216 inside the main body portion 203.

In FIG. 10, a pressure sensor 110 is provided for all of the connection tubes 216. In another example, the pressure sensor 110 may not be provided for at least one connection tube 216. For example, the pressure sensor 110 may be provided in the connection tube 216 corresponding to the tubing 210 connected to the pump 201, and the pressure sensor 110 may not be provided in any of the other connection tubes 216. In addition, the pressure sensor 110 may not be provided in one connection tube 216, but the pressure sensor 110 may be provided in all of the other connection tubes 216. The switching unit 218 of the present example connects four sets of connection tubes 216. Even if the pressure sensor 110 is not provided in any one of the connection tube 216, at least one pressure sensor 110 can be provided in each set of the connection tubes 216. In this manner, less pressure sensors 110 can be used to sense the pressure of the cooling water in the distribution channel by each set of the connection tubes 216.

The pressure sensor 110 of the present example may not include the housing 112, as illustrated in FIG. 7. A concave portion 222 may be provided on a wall of each connection tube 216, and the pressure sensor 110 may be provided in each concave portion 222. By such structure, a plurality of pressure sensors 110 can be provided even in an apparatus with relatively limited space. In another example, the plurality of pressure sensors 110 provided in the connection control unit 202 may be provided inside one sensor module.

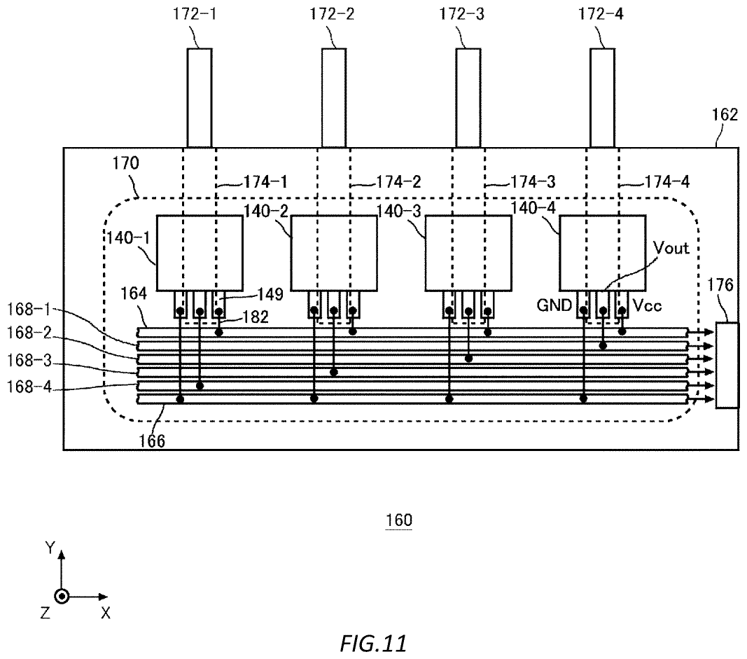

FIG. 11 is a top view describing an example of a sensor module 160. The sensor module 160 includes a plurality of sensor cells 140. The sensor module 160 may be provided in the connection control unit 202. In this case, the plurality of sensor cells 140 of the sensor module 160 sense the pressure of the cooling water in the plurality of connection tubes 216 of the connection control unit 202. In another example, the sensor module 160 may be provided in a part other than the connection control unit 202. For example, the plurality of sensor cells 140 of the sensor module 160 may sense the pressure of the cooling water at a plurality of placement positions 111 in the distribution channel. Although, in the present example, the sensor cell 140 has structure that is similar to that in the example illustrated in FIG. 4, it may have structure that is similar to that in the example illustrated in FIG. 5.

The sensor module 160 of the present example includes a main body portion 162, a plurality of sensor cells 140, a plurality of induction tubes 172, a plurality of storage units 174, a plurality of signal wirings 168, a power supply wiring 164, a power supply wiring 166, and a connector 176. The main body portion 162 is provided with the plurality of sensor cells 140. The main body portion 162 may be formed of an insulating material such as resin. The main body portion 162 may be provided with a concave portion 170 that accommodates the plurality of sensor cells 140.

The main body portion 162 is provided with the plurality of induction tubes 172. The induction tube 172 is connected to a distribution channel to be measured, such as the tubing 210 or the connection tube 216. A relay tube that connects the induction tube 172 and the distribution channel such as the tubing 210 or the connection tube 216 may be further provided. A part of the cooling water that flows through the distribution channel such as the tubing 210 or the connection tube 216 is introduced into the induction tube 172. The plurality of induction tubes 172 may be arranged on a common surface of the main body portion 162.

The storage unit 174 is provided individually for each induction tube 172. The storage unit 174 may be a space provided inside the main body portion 162. The storage unit 174 stores the cooling water from a corresponding induction tube 172. The storage unit 174 is provided to extend from the induction tube 172 to a position where it faces the sensor cell 140. The sensor cell 140 is arranged to be in contact with the cooling water in the storage unit 174, and senses the pressure of the cooling water in the storage unit 174.

The signal wiring 168 is provided for each sensor cell 140 of the sensor module 160. In the example of FIG. 11, the signal wirings 168-1 to 168-4 are provided for the sensor cells 140-1 to 140-4. Each signal wiring 168 is connected to an output terminal Vout (see FIG. 6) of a corresponding sensor cell 140.

The power supply wiring 164 is provided in common for two or more sensor cells 140 of the sensor module 160. The power source terminal Vcc of each sensor cell 140 is connected in common to the power supply wiring 164.

The power supply wiring 166 is provided in common for two or more sensor cells 140 of the sensor module 160. The power source terminal GND of each sensor cell 140 is connected in common to the power supply wiring 166.

Each wiring and each terminal are connected through wiring 182 such as a wire. The plurality of signal wirings 168, the power supply wiring 164, and the power supply wiring 166 may be provided in the concave portion 170. The plurality of signal wirings 168, the power supply wiring 164 and the power supply wiring 166 may each be a board-shaped lead frame arranged on a bottom surface of the concave portion 170. The bottom surface of the concave portion 170 may have arranged therein a wiring substrate including the plurality of signal wirings 168, the power supply wiring 164, and the power supply wiring 166. Each set of adjacent wirings of the plurality of signal wirings 168, the power supply wiring 164, and the power supply wiring 166 may have arranged therein a chip capacitor such that it connects the adjacent wirings. This chip capacitor may be provided instead of, or together with the chip capacitor 148 provided in the sensor cell 140.

The concave portion 170 may be filled with an encapsulation material of an insulating material that encapsulates the plurality of sensor cells 140 and each wiring, or may be filled with an encapsulation material of an insulating material in a thickness to the extent that the plurality of signal wirings 168, the power supply wiring 164, the power supply wiring 166, and the terminal 149 are covered and a lid portion may be provided to cover the concave portion 170 similarly to FIG. 4 or FIG. 5. Alternatively, without using an encapsulation material of an insulating material, similarly to FIG. 4, only the lid portion that covers the concave portion 170 may be provided, or similarly to FIG. 5, the only lid portion having a through-hole that covers the concave portion 170 may be provided. As the insulating material, silicone gel can be used, for example.

The plurality of signal wirings 168, the power supply wiring 164, and the power supply wiring 166 may be provided to extend in a predetermined extending direction (X-axis direction in FIG. 11). The plurality of signal wirings 168 may be arranged between the power supply wiring 164 and the power supply wiring 166 in the Y-axis direction. The plurality of sensor cells 140 of the present example are arranged in line along the extending direction of the wiring. The end side on which each terminal is provided in the accommodating portion 141 of each sensor cell 140 may be arranged to face the plurality of signal wirings 168, the power supply wiring 164, and the power supply wiring 166.

The plurality of signal wirings 168, the power supply wiring 164, and the power supply wiring 166 are connected to the connector 176. The connector 176 connects the plurality of signal wirings 168, the power supply wiring 164, and the power supply wiring 166 to the sensing unit 150.

According to the present example, since the power supply wiring 164 and the power supply wiring 166 are provided in common for a plurality of sensor cells 140, the sensor module 160 can be made compact. In addition, since the plurality of sensor cells 140 can be provided in close contact with the concave portion 170, the space to place the plurality of sensor cells 140 can be reduced. The vertical, horizontal, and height size of the main body portion 162 may be 500 mm or less, 400 mm or less, or 300 mm or less, respectively.

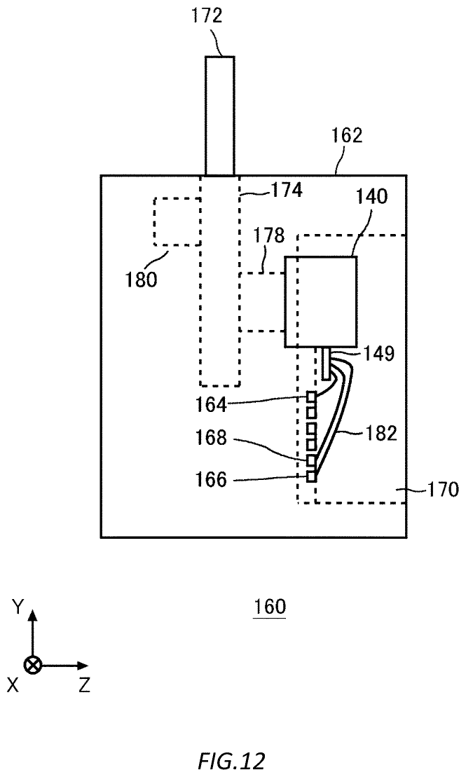

FIG. 12 is an example of a cross-sectional view of the sensor module 160 illustrated in FIG. 11. As described in FIG. 11, the storage unit 174 is provided to extend to a position where it faces the sensor cell 140. The storage unit 174 and the sensor cell 140 are connected through a connection hole 178. The cooling water stored in the storage unit 174 is brought into contact with the sensor cell 140 through the connection hole 178. The sensor cell 140 senses the pressure of the cooling water in the connection hole 178.

The storage unit 174 of the present example is terminated inside the main body portion 162. The storage unit 174 is not connected to the outside of the main body portion 162 other than where it is connected to the induction tube 172 and the sensor cell 140. Since the storage unit 174 is terminated inside the main body portion 162, movement of the cooling water inside the storage unit 174 is suppressed. Thus, friction between the cooling water and the sensor cell 140 can be suppressed, which leads to suppressing charging of the sensor cell 140. On the other hand, since the storage unit 174 is connected to the tubing 210 or the like via the induction tube 172, the pressure of the cooling water in the tubing 210 or the like can be sensed by the sensor cell 140.

The storage unit 174 may extend from the induction tube 172 to the connection hole 178 and terminate at a position past the connection hole 178. In the storage unit 174, the portion beyond the connection hole 178 may function as an air reservoir in which gas such as air is stored. The portion beyond the connection hole 178 in the storage unit 174 may include a portion that protrudes upward in the gravity direction. By providing an air reservoir, storage of gas in the path from the tubing 210 or the like to the sensor cell 140 can be suppressed. In this manner, loss of pressure transmission from the tubing 210 or the like to the sensor cell 140 can be suppressed.

The main body portion 162 may further include a surge tank 180. The surge tank 180 is a portion where the cross-sectional area of the storage unit 174 is enlarged in a surface perpendicular to the extending direction (the Y-axis direction in the present example) of the storage unit 174. The surge tank 180 may be provided at a position closer to the induction tube 172 relative to the connection hole 178. The cross-sectional area of the storage unit 174 at the position where the surge tank 180 is provided may be greater than the cross-sectional area of the storage unit 174 between the surge tank 180 and the connection hole 178, and may be greater by two times or more. By providing the surge tank 180, the impact of the cooling water on the sensor cell 140 can be relaxed even when the flow rate or pressure of the cooling water that flows through the tubing 210 or the like varies rapidly.

In a case where the surge tank 180 is not included, for example, the main body portion 162 can be formed integrally with the plurality of the signal wirings 168, the power supply wiring 164, and the power supply wiring 166 by means of resin molding. In a case where the surge tank 180 is included, after forming the main body portion 162 without the surge tank 180, a through-hole that reaches to the storage unit 174 in the Z direction from an opposite side of the main body portion 162 relative to the concave portion 170 illustrated in FIG. 12 is provided, and the main body portion 162 can be formed by providing a lid portion such that the opening of this through-hole is covered.

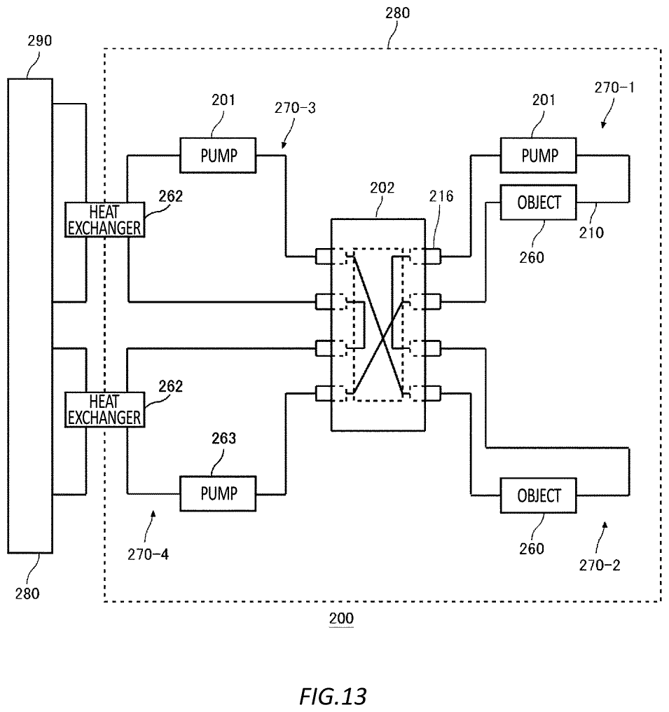

FIG. 13 illustrates another configuration example of the distribution portion 200. The distribution portion 200 of the present example includes a first cooling system 280 and a second cooling system 290. The first cooling system 280 cools an object 260 by causing the cooling water to circulate through the distribution channel, similarly to the distribution portion 200 described in FIG. 1 to FIG. 12. The second cooling system 290 cools the object by causing a coolant different from the cooling water to circulate through the distribution channel. The distribution coolant in the second cooling system 290 may include gas such as vapor, for example. The pressure sensor 110 is provided in the first cooling system 280. The second cooling system 290 may not be provided with the pressure sensor 110.

The first cooling system 280 and the second cooling system 290 are thermally attached through one or more heat exchangers 262. Each heat exchanger 262 exchanges heat between the cooling water in the first cooling system 280 and the coolant in the second cooling system 290.

The first cooling system 280 of the present example includes a plurality of annular paths 270-1 to 270-4. Each annular path 270 is a distribution channel having two ends. The cooling water that entered one end of the annular path 270 passes through the distribution channel to be discharged from the other end. Both ends of the annular path 270 are connected to the connection tube 216 of the connection control unit 202. Each annular path 270 may be provided with a pump 201, may be provided with a tank 263 in which the cooling water is stored, may be provided with an object 260 to be cooled, may be provided with a heat exchanger 262, or may be provided with two or more of the above.

The connection control unit 202 of the present example is capable of connecting two or more annular paths 270, among the plurality of annular paths 270, to one another. The connection control unit 202 may connect two or more annular paths 270 such that they constitute one annular path. The annular path is a path through which the cooling water is circulated.

The connection control unit 202 of the present example is provided with one or more pressure sensors 110, as illustrated in FIG. 10. The structure of the distribution channel downstream of each pressure sensor 110 is changed depending on which of the annular paths 270 the connection control unit 202 is connected to. Thus, the pressure to be sensed by each pressure sensor 110 at normal operation changes depending on the state of the connection control unit 202. The sensing unit 150 may correct the reference value for each pressure sensor 110 depending on which of the annular paths the connection control unit 202 has connected together. A reference value for each pressure sensor 110 may be set to the sensing unit 150 for each connection state in the connection control unit 202.

The distribution channel may be provided with a direction control unit that controls the direction in which the cooling water flows. For example, by switching the inlet and the outlet in the pump 201 with each other, the direction in which the cooling water flows can be controlled. In this case, the pump 201 functions as the direction control unit. In addition, when the connection control unit 202 replaces the connection destination of both ends of one annular path 270 with each other, the cooling water flows in an opposite direction through said annular path 270. In this case, the connection control unit 202 functions as the direction control unit.

Since the direction downstream of each pressure sensor 110 is changed when the direction in which the cooling water flows is changed, the structure on the downstream side of the pressure sensor 110 is changed. Thus, the pressure to be sensed by each pressure sensor 110 at normal operation changes depending on the direction in which the cooling water flows. The sensing unit 150 may correct the reference value for each pressure sensor 110 according to the direction in which the cooling water flows. A reference value for each pressure sensor 110 may be set to the sensing unit 150 for each direction in which the cooling water flows.

In each embodiment described herein, the sensing unit 150 may correct said reference value according to the operative condition of the distribution portion 200. For example, an appropriate pressure of the cooling water at each position in the distribution channel varies according to the operative condition of the pump 201. The sensing unit 150 may correct said reference value according to the operative condition of the pump 201. The operative condition of the pump 201 may be at least one of a discharge pressure, an intake pressure, a discharge flow rate, or an intake flow rate of the pump 201, for example.

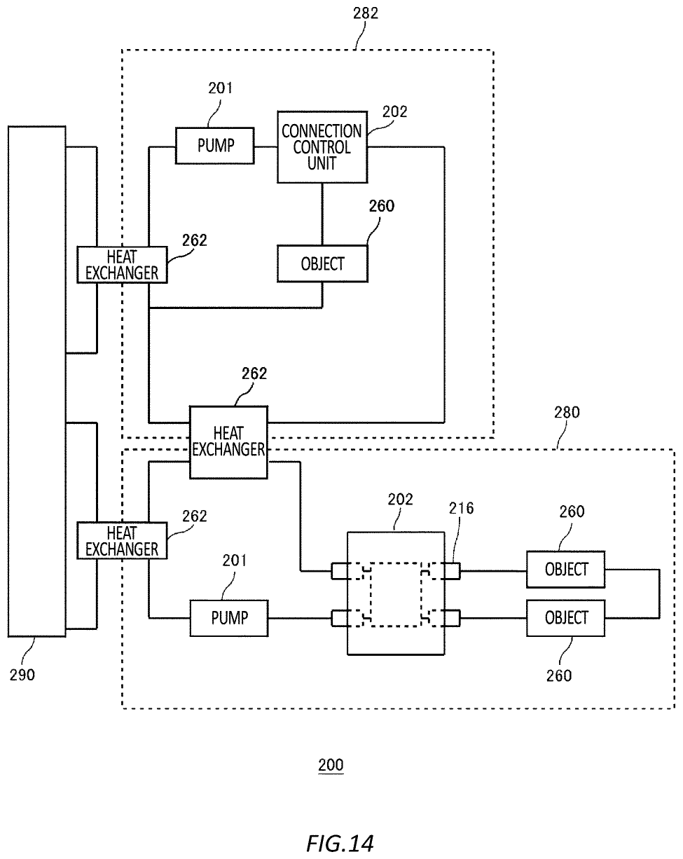

FIG. 14 illustrates another configuration example of the distribution portion 200. The distribution portion 200 of the present example includes a first cooling system 280, a second cooling system 290, and a third cooling system 282. The second cooling system 290 is similar to that in the example of FIG. 13. The third cooling system 282 cools an object 260 by causing the cooling water to circulate through the distribution channel, similarly to the distribution portion 200 described in FIG. 1 to FIG. 12. The temperature of the cooling water that flows through the third cooling system 282 may be higher than that of the cooling water that flows through the first cooling system 280.

The first cooling system 280 and the second cooling system 290 are thermally attached through one or more heat exchangers 262. The third cooling system 282 and the second cooling system 290 may also be thermally attached through one or more heat exchangers 262. In addition, the first cooling system 280 and the third cooling system 282 may also be thermally attached through one or more heat exchangers 262.

The pressure sensor 110 may be provided in both of the first cooling system 280 and the third cooling system 282. The sensing unit 150 monitors the state of the distribution channel in each of the first cooling system 280 and the third cooling system 282.

In each embodiment described herein, each sensor cell 140 may have the same structure or may have different structures. As an example, the sensing system 100 may be provided with a sensor cell 140 with a different thickness or material of the encapsulating portion 144 from other sensor cells 140.

Each sensor cell 140 may include a pressure sensor with different sensitivity. As an example, in the sensing system including a plurality of distribution channels, when a distribution channel for the cooling water with different pressure is included, a pressure sensor with optimal sensitivity for each pressure may be used. One distribution channel in this case may refer to one tubing 210, may refer to an apparatus such as one connection control unit 202 or may refer to one consecutive space 211 in which the pressure of the cooling water is equivalent. In addition, when a plurality of pumps 201 are included in the cooling system, a path between two pumps 201 may be treated as one distribution channel. Different sensitivity may refer to the pressure value at which the sensitivity becomes the highest being different, may refer to the measurable pressure range being different, or may refer to the pressure measurement resolution being different, for example.

As another example, a pressure sensor with a sensitivity for measuring the pressure of the cooling water during normal operation, for example, 300 kPa or less and a pressure sensor with a higher sensitivity for measuring 10 kPa, for example, for diagnostic purpose of sensing leakage or clogging of the distribution channel may be used together for the same distribution channel.

Some places where air bubbles tend to be generated in the cooling water may exist in the distribution channel. For example, air bubbles are more likely to be generated at a place where the pressure change of the cooling water is rapid, such as near the pump 201, or a place where the distribution channel is terminated. When air bubbles are generated in the cooling water, the encapsulating portion 144 of the sensor cell 140 may be grinded by the air bubbles.

A first sensor cell 140 with a relatively small distance from the pump 201 or the terminal end of the distribution channel may be larger in thickness at the encapsulating portion 144 than a second sensor cell 140 with a relatively large distance from the pump 201 or the terminal end of the distribution channel. At least a portion of the encapsulating portion 144 of the first sensor cell 140 may be formed of a material having a higher hardness than that of the encapsulating portion 144 of the second sensor cell 140. The encapsulating portion 144 of the first sensor cell 140 may be covered with a material having a higher hardness than that of the encapsulating portion 144 of the second sensor cell 140. In this manner, the reliability of the first sensor cell 140 can be improved.

While the present invention has been described by way of the embodiments, the technical scope of the present invention is not limited to the above-described embodiments. It is apparent to persons skilled in the art that various alterations or improvements can be made to the above-described embodiments. It is also apparent from the described scope of the claims that the embodiments added with such alterations or improvements can be included the technical scope of the present invention.

What is claimed is:

1. A temperature adjustment apparatus that performs thermal exchange with one or more objects by means of cooling water, the temperature adjustment apparatus comprising:
a distribution portion including a distribution channel through which the cooling water is distributed; and
a sensing system that senses a state of the distribution channel, wherein
the sensing system includes:
a pressure sensor provided at at least one position in the distribution channel, that senses pressure of the cooling water; and
a sensing unit that senses a state of the distribution channel based on the pressure sensed by the pressure sensor.

2. The temperature adjustment apparatus according to claim 1, wherein
the distribution channel includes:
a plurality of tubing; and
a connection control unit that controls which of the plurality of tubing are to be connected together,
wherein the connection control unit includes:
a plurality of connection tubes connected to the plurality of tubing; and
a switching unit that switches which of the plurality of connection tubes are to be connected together, and
at least one of the pressure sensor is provided on at least one of the connection tubes.

3. The temperature adjustment apparatus according to claim 1, wherein the distribution channel includes:
a major path;
a plurality of branch paths; and
a connection control unit that controls which of the plurality of branch paths is to be connected to the major path,
wherein the pressure sensor is provided on the major path,
the sensing unit compares the pressure sensed by the pressure sensor with a reference value, and senses a state of the distribution channel based on a comparison result, and
the sensing unit corrects the reference value depending on which of the branch paths the connection control unit selected.

4. The temperature adjustment apparatus according to claim 1, wherein the distribution channel includes:
a plurality of annular paths; and
a connection control unit that is capable of connecting two or more annular paths of the plurality of annular paths with each other,
wherein the sensing unit compares the pressure sensed by the pressure sensor with a reference value, and senses a state of the distribution channel based on a comparison result, and
the sensing unit corrects the reference value depending on which of the annular paths the connection control unit connected.

5. The temperature adjustment apparatus according to claim 1, wherein
the distribution channel includes a direction control unit that controls a direction in which the cooling water flows, and
the sensing unit senses a state of the distribution channel based on the pressure sensed by the pressure sensor and a direction in which the cooling water flows, which is controlled by the direction control unit.

6. The temperature adjustment apparatus according to claim 1, wherein
the pressure sensor includes a sensor cell that generates a sensing signal according to the pressure of the cooling water, and
at least a part of the sensor cell is covered with a protective film connected to a reference potential.

7. The temperature adjustment apparatus according to claim 1, wherein
the distribution channel includes a wall that surrounds a space through which the cooling water passes,
an opening is provided in the wall, and
the pressure sensor includes:
an intake unit connected to the opening in the wall, which takes in the cooling water; and
a sensor cell that senses the pressure of the cooling water taken in by the intake unit.

8. The temperature adjustment apparatus according to claim 1, wherein
the distribution channel includes a wall that surrounds a space through which the cooling water passes,
the wall includes:
a concave portion provided on a surface on an opposite side from the space; and
an opening that connects the concave portion with the space, and
the pressure sensor includes a sensor cell arranged inside the concave portion, which senses the pressure of the cooling water.

9. The temperature adjustment apparatus according to claim 1, wherein
the pressure sensor includes a sensor cell having an output terminal that outputs a sensing signal according to the pressure of the cooling water and a power supply terminal to which power voltage is applied, and
the sensor cell includes a chip capacitor that connects the output terminal with the power supply terminal.

10. The temperature adjustment apparatus according to claim 1, comprising a plurality of pressure sensors, each pressure sensor being identical to the pressure sensor, wherein
each of the pressure sensors include a sensor cell having an output terminal that outputs a sensing signal according to the pressure of the cooling water and a power supply terminal to which power voltage is applied, and
the sensing system includes:
a signal wiring provided for each of two or more sensor cells, each being identical to the sensor cell, to which the output terminal of each of the sensor cells is connected; and
a power supply wiring that is provided in common for the two or more sensor cells, to which the power supply terminal of each of the sensor cells is connected in common.

11. The temperature adjustment apparatus according to claim 10, comprising a sensor module including a plurality of sensor cells, each sensor cell being identical to the sensor cell, the signal wiring, and the power supply wiring,
wherein the sensor module includes:
a main body portion in which the plurality of sensor cells, the signal wiring, and the power supply wiring are provided;
an induction tube provided for each of the sensor cells, which introduces the cooling water into the main body portion; and
a storage unit for storing the cooling water, which is provided inside the main body portion to extend from the induction tube to a position facing the sensor cell, and
each of the plurality of sensor cells senses pressure of the cooling water in the storage unit.

12. The temperature adjustment apparatus according to claim 11, wherein
the storage unit is terminated inside the main body portion.

13. The temperature adjustment apparatus according to claim 12, wherein
the main body portion includes:
a connection hole that connects the storage unit with the sensor cell; and
a surge tank provided at a position closer to the induction tube relative to the connection hole.

14. The temperature adjustment apparatus according to claim 1, wherein
the sensing system includes:
a plurality of distribution channels having different pressure of the cooling water, each distribution channel being identical to the distribution channel; and
a plurality of pressure sensors having different sensitivity according to the pressure of the cooling water, each pressure sensor being identical to the pressure sensor, and each being provided in the plurality of distribution channels.

15. The temperature adjustment apparatus according to claim 10, wherein the sensing system comprises the plurality of pressure sensors having different sensitivity,
wherein each of the pressure sensors is provided in one distribution channel.

16. A sensing system that senses a state of a distribution channel through which cooling water is distributed, comprising:
a pressure sensor provided at at least one position in the distribution channel, which senses pressure of the cooling water; and
a sensing unit that senses a state of the distribution channel based on the pressure sensed by the pressure sensor.

17. The temperature adjustment apparatus according to claim 2, wherein
the pressure sensor includes a sensor cell that generates a sensing signal according to the pressure of the cooling water, and
at least a part of the sensor cell is covered with a protective film connected to a reference potential.

18. The temperature adjustment apparatus according to claim 3, wherein
the pressure sensor includes a sensor cell that generates a sensing signal according to the pressure of the cooling water, and
at least a part of the sensor cell is covered with a protective film connected to a reference potential.

19. The temperature adjustment apparatus according to claim 4, wherein
the pressure sensor includes a sensor cell that generates a sensing signal according to the pressure of the cooling water, and
at least a part of the sensor cell is covered with a protective film connected to a reference potential.

20. The temperature adjustment apparatus according to claim 5, wherein
the pressure sensor includes a sensor cell that generates a sensing signal according to the pressure of the cooling water, and
at least a part of the sensor cell is covered with a protective film connected to a reference potential.
